(19) United States
(12) Patent Application Publication
(10) Pub. No.: US 2026/0311923 A1
(43) Pub. Date: Oct. 8, 2026

(54) SPACE ELECTROMAGNETIC FIELD GENERATOR AND FRESHNESS MAINTENANCE DEVICE USING THE SAME

(71) Applicant: Lynn Gull PARK, Busan (KR)

(72) Inventor: Lynn Gull PARK, Busan (KR)

(21) Appl. No.: 19/684,988

(22) Filed: May 21, 2026

(30) Foreign Application Priority Data
Apr. 2, 2025 (KR) 10-2025-0043037

(51) Int. Cl. H01F 7/20; A23B 2/50; A23B 2/80; A23B 4/015; A23B 4/06; H01F 7/06

(52) U.S. Cl. CPC H01F 7/202; A23B 2/50; A23B 2/805; A23B 4/015; A23B 4/066; H01F 7/064

(57) ABSTRACT

A space electromagnetic field generator includes: a transformer formed by magnetically coupling a primary coil and a secondary coil; a power supply unit configured to apply an AC voltage to the primary coil; and a discharge unit electrically coupled to one end of the secondary coil and configured to generate an electromagnetic field in a surrounding space. An insulating device is included in a line electrically connecting a positive terminal of the secondary coil and a negative terminal of the primary coil. The space electromagnetic field generator further includes a resonance circuit unit through which a voltage induced in the secondary coil passes before being transmitted to the discharge unit and which adjusts an oscillation frequency of the secondary coil to 430 to 440 Hz.

### CROSS REFERENCE TO RELATED APPLICATION

The present application claims priority to Korean Patent Application No. 10-2025-0043037, filed Apr. 2, 2025, the entire contents of which is incorporated herein for all purposes by this reference.

### BACKGROUND OF THE INVENTION

### Field of the Invention

The present invention relates to a space electromagnetic field generator and a freshness maintenance device using the same.

### Description of the Related Art

Conventional technologies for storing foods have mainly been based on temperature and humidity control technologies and packaging technologies in order to maintain freshness. Refrigeration and freezing technologies are the most widely used methods, in which the growth of microorganisms and chemical reactions are inhibited by low temperatures. Refrigerators are designed to store foods within a temperature range of 0 to 4° C., and freezers are designed to store foods for a long period of time at −18° C. or lower. Vacuum packaging or a method of filling an inert gas reduces contact with oxygen and thereby prevents oxidation.

However, in the case of a freshness maintenance device employing conventional refrigeration and freezing technologies, rapid freezing of foods requires a temperature condition of −60° C., which results in excessively high energy consumption. In addition, in the case of foods such as meat, fish, and vegetables, water molecules contained in the foods are transformed into a sharp hexagonal shape during freezing, thereby causing damage to cell membranes. As a result, when the foods are thawed, drip is generated from the foods, which seriously deteriorates their commercial value.

Recently, attempts have been made to apply electromagnetic fields to maintaining the freshness of foods. It is known that electromagnetic fields inhibit the growth of microorganisms in foods, prevent oxidation, and improve freshness by regulating cellular activity.

A space electromagnetic field generator applied to a freshness maintenance device generally has a structure including: a transformer formed by magnetically coupling a primary coil and a secondary coil; a power supply configured to apply an AC voltage to the primary coil; and a discharge plate electrically coupled to one end of the secondary coil and configured to generate an electromagnetic field in a surrounding space.

However, since the discharge plate is installed in an exposed state in one region of a food storage space, for example, a food receiving space of a refrigerator, in order to emit an electromagnetic field into the food storage space, moisture or foreign substances are accumulated on the surface of the discharge plate during long-term use. This causes deterioration in the performance of forming the electromagnetic field and becomes a factor that reduces the sustainability of freshness maintenance performance.

In addition, in the case of a transformer of a space electromagnetic field generator applied to a conventional freshness maintenance device, the positive terminal of the secondary coil and the negative terminal of the primary coil are often electrically connected in order to increase electromagnetic field generation efficiency. However, in this case, a short circuit or overcurrent may occur due to the high voltage applied to the secondary coil, thereby causing damage to the transformer. As a result, the sustainability of oscillation performance for maintaining freshness is impaired.

### SUMMARY OF THE INVENTION

The present invention has been made to overcome the above-described problems, and an object of the present invention is to provide a space electromagnetic field generator and a freshness maintenance device using the same, which are capable of maintaining the freshness of foods for a long period of time, enabling rapid freezing of foods at a temperature much higher than the conventional temperature of −60° C., and minimizing the generation of drip when the foods are thawed.

Another object of the present invention is to provide a space electromagnetic field generator and a freshness maintenance device using the same, which are capable of minimizing the accumulation of moisture or foreign substances on the surface of a discharge plate even during long-term use, and thus maintaining electromagnetic field emission performance for a long period of time without deterioration.

Still another object of the present invention is to provide a space electromagnetic field generator and a freshness maintenance device using the same, in which a transformer is not damaged even when the positive terminal of a secondary coil and the negative terminal of a primary coil are electrically connected, and which have high sustainability of oscillation performance for maintaining freshness.

The technical problems to be solved by the present invention are not limited to the technical problems mentioned above, and other technical problems not mentioned herein will be clearly understood by those skilled in the art from the following description.

The present invention for solving the above-described problems relates to a space electromagnetic field generator, and more specifically, includes: a transformer formed by magnetically coupling a primary coil and a secondary coil; a power supply unit configured to apply an AC voltage to the primary coil; and a discharge unit electrically coupled to one end of the secondary coil and configured to generate an electromagnetic field in a surrounding space. The space electromagnetic field generator is characterized in that an insulating device is included in a line electrically connecting a positive terminal of the secondary coil and a negative terminal of the primary coil, and further includes a resonance circuit unit through which a voltage induced in the secondary coil passes before being transmitted to the discharge unit and which adjusts an oscillation frequency of the secondary coil to 430 to 440 Hz.

In addition, another aspect of the present invention relates to a freshness maintenance device, and more specifically, includes: the above-described space electromagnetic field generator; and a food storage unit having a space formed therein for receiving foods to be stored, wherein the discharge unit of the space electromagnetic field generator is installed so as to be exposed to the inside of the space.

When foods are preserved using the space electromagnetic field generator according to the present invention, the freshness of the foods can be maintained for a long period of time. In addition, when foods are rapidly frozen, rapid freezing can be sufficiently performed even at −5° C., which is much higher than the conventional temperature of −60° C. Furthermore, when the foods are thawed, the generation of drip can be minimized.

In addition, the space electromagnetic field generator according to the present invention can minimize the accumulation of moisture or foreign substances on the surface of the discharge plate even during long-term use, thereby maintaining electromagnetic field emission performance for a long period of time without deterioration.

In addition, since the space electromagnetic field generator according to the present invention includes the insulating device in the line connecting the secondary coil and the primary coil, the risk of damage to the transformer can be minimized, and the sustainability of oscillation performance for maintaining freshness can be improved.

### BRIEF DESCRIPTION OF THE DRAWINGS

FIG. 1 is a circuit diagram illustrating a space electromagnetic field generator according to an embodiment of the present invention.

FIG. 2 conceptually illustrates the structure of a freshness maintenance device according to another aspect of the present invention.

FIG. 3 shows results of a comparative experiment on freshness maintenance performance for foods between a case where the space electromagnetic field generator of the present invention is applied to a general refrigerator and a case where it is not applied thereto.

FIG. 4 shows results of a comparative experiment on rapid freezing performance and whether drip is generated during thawing, for foods, between a case where the space electromagnetic field generator of the present invention is applied to a general freezer and a case where it is not applied thereto.

FIG. 5 shows results of an experiment on the degree of accumulation of foreign substances on a discharge plate of a discharge unit according to oscillation frequencies of a secondary coil of a transformer.

### DETAILED DESCRIPTION OF THE INVENTION

Hereinafter, a preferred embodiment of the present invention will be described in detail with reference to the accompanying drawings. The following embodiment is merely an example for describing the present invention, and the scope of the present invention is not limited thereby.

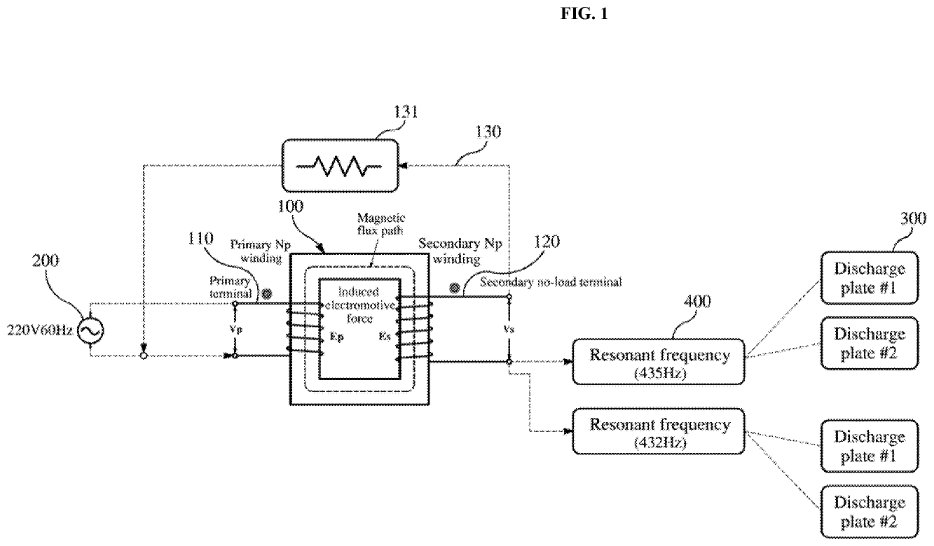

FIG. 1 is a circuit diagram illustrating a space electromagnetic field generator according to an embodiment of the present invention.

Referring to FIG. 1, the space electromagnetic field generator according to the present invention includes: a transformer 100 formed by magnetically coupling a primary coil 110 and a secondary coil 120; a power supply unit 200 configured to apply an AC voltage to the primary coil 110; and a discharge unit 300 electrically coupled to one end of the secondary coil 120 and configured to generate an electromagnetic field in a surrounding space.

In the present invention, the transformer 100 is formed by magnetically coupling the primary coil 110 and the secondary coil 120, and includes an iron core, the primary coil 110, and the secondary coil 120. The iron core functions to concentrate a magnetic field and minimize energy loss, and the primary coil 110 and the secondary coil 120 are magnetically coupled to transfer energy. AC power is supplied to the primary coil 110 to form a magnetic field, and the secondary coil 120 generates an induced voltage through the formed magnetic field.

In the transformer 100 of the present invention, a voltage conversion ratio is determined depending on the number of turns of the coils and the material of the iron core. A turns ratio “a” of the number of turns N₁ of the primary coil 110 to the number of turns N₂ of the secondary coil 120 is preferably expressed as a =N₁/N₂=0.07 to 0.11, and most preferably, a =N₁/N₂=0.09.

When the turns ratio “a” is less than 0.07, the AC voltage induced in the secondary coil 120 becomes excessively high, thereby causing damage to the discharge unit 300 including a discharge plate or the like, or causing corona discharge due to ionization of surrounding air, which deteriorates the uniformity of the electromagnetic field. When the turns ratio “a” is greater than 0.11, the AC voltage induced in the secondary coil 120 becomes excessively low, and thus a sufficient electromagnetic field cannot be generated by the discharge unit 300. As a result, freshness of the entirety of foods in the space cannot be uniformly maintained, or the resonance circuit does not properly operate, thereby causing an error in frequency adjustment.

Meanwhile, in order to suppress generation of electrical noise caused by the secondary coil 120 to which a high voltage is applied, to allow the high voltage to be smoothly applied to the secondary coil 120 and thereby increase electromagnetic field generation efficiency, and to support efficient operation of the resonance circuit, it is preferable that the positive terminal of the secondary coil 120 and the negative terminal of the primary coil 110 be electrically connected to each other.

In this case, in order to prevent damage to the transformer 100 caused by a short circuit or overcurrent resulting from direct connection through a line 130, and to improve the sustainability of oscillation performance for maintaining freshness, it is preferable that an insulating device 131 be included in the line 130 electrically connecting the positive terminal of the secondary coil 120 and the negative terminal of the primary coil 110.

The insulating device 131 may employ various known materials, forms, and structures, as long as it can provide sufficient electrical insulation so that electrical connection between the primary coil 110 and the secondary coil 120 can be stably performed.

In the present invention, the power supply unit 200 generates a stable AC voltage and applies the AC voltage to the primary coil 110. As the AC voltage is applied to the primary coil 110, a magnetic field is formed. According to the example illustrated in FIG. 1, an AC voltage of 220 V having a frequency of 60 Hz is applied to the primary coil 110.

In the present invention, the discharge unit 300 is electrically coupled to one end of the secondary coil 120 and emits the induced voltage into a surrounding space as an electromagnetic field. The discharge unit 300 emits energy generated at a high voltage into the surrounding space to form an electromagnetic field in the space.

The discharge unit 300 may include a discharge plate, a discharge electrode, or the like made of a conductive material. The discharge unit 300 may include a single discharge plate or a plurality of discharge plates according to the size of the space in which the electromagnetic field is to be formed. However, in order to form a uniform electromagnetic field in a wide receiving space and to minimize spatial restrictions when storing foods, it may be preferable that the discharge unit 300 include a plurality of discharge plates. According to the example illustrated in FIG. 1, the discharge unit 300 includes a total of four discharge plates.

The discharge plate may be designed in a flat plate shape, a curved shape, or a shape having a specific pattern formed thereon, and may be appropriately designed according to the directionality and concentration of the electromagnetic field formed in the space.

The space electromagnetic field generator according to the present invention is characterized by further including a resonance circuit unit 400 through which the voltage induced in the secondary coil 120 passes before being transmitted to the discharge unit 300 and which adjusts the oscillation frequency of the secondary coil 120 to 430 to 440 Hz.

By adjusting the oscillation frequency of the secondary coil 120 to 430 to 440 Hz through the resonance circuit unit 400, when foods are exposed to the electromagnetic field, water molecules present in the foods are oriented or aligned. As a result, the growth of microorganisms such as bacteria and fungi is inhibited, oxidation is prevented, and an antimicrobial effect is exhibited, thereby allowing the freshness of foods to be maintained for a long period of time.

In addition, even when foods are frozen, rapid freezing, which was conventionally possible at −60° C., can be sufficiently performed even at −5° C. During freezing, water molecules are frozen not in a sharp hexagonal shape but in a blunt spherical shape. Accordingly, in the case of foods such as fish and meat, cell membranes are hardly destroyed during the freezing process, and therefore the generation of drip, which is a phenomenon in which nutrients leak out during subsequent thawing, can be suppressed.

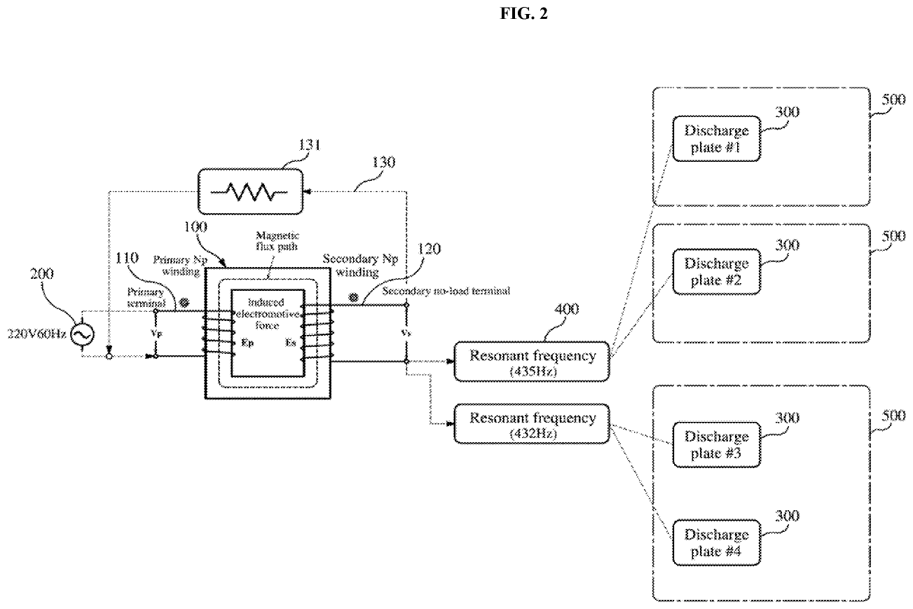

FIG. 2 conceptually illustrates the structure of a freshness maintenance device according to another aspect of the present invention.

Referring to FIG. 2, another aspect of the present invention relates to a freshness maintenance device, and more specifically, includes: the above-described space electromagnetic field generator; and a food storage unit 500 having a space formed therein for receiving foods to be stored, wherein the discharge unit 300 of the space electromagnetic field generator is installed so as to be exposed to the inside of the space.

The food storage unit 500 is not particularly limited as long as it has a space capable of receiving foods. However, it is preferable that the food storage unit 500 have a refrigerating or freezing function. In this case, when the refrigerating function is used and an electromagnetic field is emitted from the discharge unit 300, the freshness of foods received in the internal space can be maintained for a much longer period of time.

When the freezing function is used and an electromagnetic field is emitted from the discharge unit 300, as described above, rapid freezing, which was conventionally possible at −60° C., can be sufficiently performed even at −5° C. During freezing, water molecules are frozen not in a sharp hexagonal shape but in a blunt spherical shape. Accordingly, in the case of foods such as fish and meat, cell membranes are hardly destroyed during the freezing process, and therefore the generation of drip, which is a phenomenon in which nutrients leak out during subsequent thawing, can be suppressed.

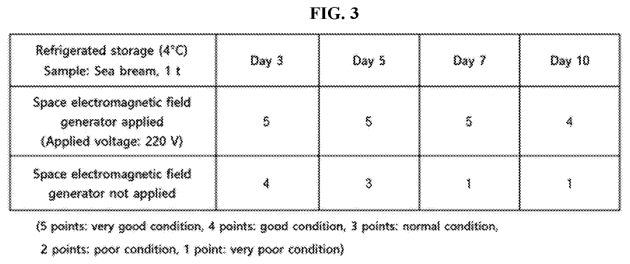

FIG. 3 shows results of a comparative experiment on freshness maintenance performance for foods between a case where the space electromagnetic field generator of the present invention is applied to a general refrigerator and a case where it is not applied thereto.

Referring to FIG. 3, one ton of sea bream was used as a sample, and when the sea bream was refrigerated at a temperature of 4° C., in the case where the space electromagnetic field generator according to the present invention was applied, the condition of the sea bream was very good until seven days had elapsed, and was still good even at the time point when ten days had elapsed.

However, in the case where the space electromagnetic field generator was not applied, the condition of the sea bream rapidly deteriorated from the fifth day, and after seven days had elapsed, putrefaction had progressed severely and the condition was very poor. That is, when the space electromagnetic field generator according to the present invention is applied to freshness maintenance, the freshness of foods can be maintained for a longer period of time.

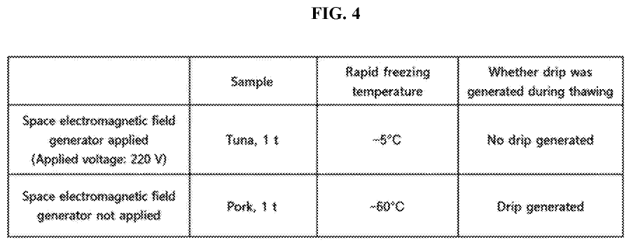

FIG. 4 shows results of a comparative experiment on rapid freezing performance and whether drip is generated during thawing, for foods, between a case where the space electromagnetic field generator of the present invention is applied to a general freezer and a case where it is not applied thereto.

Referring to FIG. 4, one ton of tuna and one ton of pork were used as samples. In the case where the space electromagnetic field generator according to the present invention was applied, rapid freezing was possible even at −5° C., and it was confirmed that no drip was generated during thawing after freezing. However, in the case where the space electromagnetic field generator was not applied, rapid freezing was possible only at −60° C., and drip was generated during thawing after freezing.

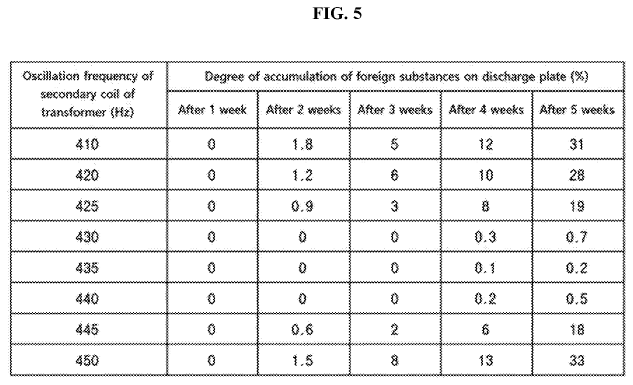

FIG. 5 shows results of an experiment on the degree of accumulation of foreign substances on the discharge plate of the discharge unit according to oscillation frequencies of the secondary coil of the transformer.

Referring to FIG. 5, when the oscillation frequency of the secondary coil was adjusted to various values by the resonance circuit unit, almost no foreign substances were accumulated on the discharge plate of the discharge unit even after a use period of five weeks or more when the oscillation frequency was 430 to 440 Hz. Accordingly, it can be seen that deterioration in electromagnetic field emission performance hardly occurs even during long-term use.

As described above, those skilled in the art to which the present invention pertains will understand that the present invention can be embodied in other specific forms without changing the technical spirit or essential features thereof. The scope of the present invention should be defined by the claims described below rather than by the detailed description above, and all modifications or variations derived from the meaning and scope of the claims and equivalents thereof should be construed as being included in the scope of the present invention.

What is claimed is:

1. A space electromagnetic field generator comprising:
a transformer formed by magnetically coupling a primary coil and a secondary coil;
a power supply unit configured to apply an AC voltage to the primary coil; and
a discharge unit electrically coupled to one end of the secondary coil and configured to generate an electromagnetic field in a surrounding space,
wherein an insulating device is included in a line electrically connecting a positive terminal of the secondary coil and a negative terminal of the primary coil;
wherein the space electromagnetic field generator further comprises a resonance circuit unit through which a voltage induced in the secondary coil passes before being transmitted to the discharge unit, the resonance circuit unit being configured to adjust an oscillation frequency of the secondary coil to 430 to 440 Hz; and
wherein the transformer has a turns ratio “a” of a number of turns N₁ of the primary coil to a number of turns N₂ of the secondary coil, the turns ratio being expressed as a=N₁/N₂=0.07 to 0.11.

2. The space electromagnetic field generator according to claim 1,
wherein the discharge unit includes a plurality of discharge plates.

3. A freshness maintenance device comprising:
the space electromagnetic field generator according to claim 1; and
a food storage unit having a space formed therein for receiving food to be stored,
wherein the discharge unit of the space electromagnetic field generator is installed such that the discharge unit is exposed to inside of the space.

4. The freshness maintenance device according to claim 3,
wherein the food storage unit has a refrigerating or freezing function.
